(19) United States
(12) Patent Application Publication
(10) Pub. No.: US 2018/0210284 A1
(43) Pub. Date: Jul. 26, 2018

(54) DISPLAY DEVICE AND ELECTRONIC SHELF LABEL

(71) Applicant: Japan Display Inc., Tokyo (JP)

(72) Inventors: Yudai NUMATA, Tokyo (JP); Masaya TAMAKI, Tokyo (JP); Takeo KOITO, Tokyo (JP)

(21) Appl. No.: 15/877,810

(22) Filed: Jan. 23, 2018

(30) Foreign Application Priority Data
Jan. 25, 2017 (JP) 2017-011430

(51) Int. Cl. G02F 1/1335; G02B 5/04

(52) U.S. Cl. CPC G02F 1/133526; G02F 1/133553; G02F 2001/133531; G02B 5/045; G02F 1/133528

(57) ABSTRACT

According to an aspect, a lens sheet outputs light reflected by a reflector, the reflected light being a part of incident light having entered the lens sheet. When a first light intensity is an intensity of light entering the lens sheet at an incident angle from 70° to 90° inclusive with respect to a normal direction of a display surface and output from the lens sheet at an output angle from 0° to 40° inclusive toward an incident side with respect to the normal direction, and a second light intensity is an intensity of light entering the lens sheet at an incident angle from 10° to 40° inclusive with respect to the normal direction and output from the lens sheet at an output angle from 0° to 40° inclusive to the incident side with respect to the normal direction, the first light intensity is greater than the second light intensity.

### CROSS-REFERENCE TO RELATED APPLICATIONS

This application claims priority from Japanese Application No. 2017-011430, filed on Jan. 25, 2017, the contents of which are incorporated by reference herein in its entirety.

### BACKGROUND

### 1. Technical Field

The present disclosure relates to a display device and an electronic shelf label.

### 2. Description of the Related Art

Examples of display devices include, other than a transmissive display device that performs display by using transmitted light of a backlight on the back surface of a screen, a reflective liquid-crystal display device that performs display by using reflected light. For example, Japanese Patent Application Laid-open Publication No. 2002-214603 (JP-A-2002-214603) discloses a technology that improves visibility in a normal direction of a display surface.

In the technology described in JP-A-2002-214603, a prism array sheet is set such that incident light entering from an inclination range of 10° to 45° with respect to the normal direction of the display surface is output to a substantially normal direction of the display surface. Thus, assuming that a panel is placed perpendicularly to a floor surface under an environment in which a lighting fixture is mounted on the ceiling, an observer may have a difficulty to visually recognize an image displayed on the panel, when an observer looks into the panel obliquely from above the panel.

### SUMMARY

According to an aspect, a display device includes: a display portion including a liquid crystal layer; a lens sheet arranged on a display surface of the display portion; and a reflector arranged on an opposite side of the lens sheet with the liquid crystal layer interposed between the reflector and the lens sheet. The lens sheet outputs light reflected by the reflector, the reflected light being a part of incident light that has entered the lens sheet. When a first light intensity is an intensity of light entering the lens sheet at an incident angle ranging from equal to or more than 70° to equal to or less than 90° with respect to a normal direction of the display surface, and, output from the lens sheet at an output angle ranging from equal to or more than 0° to equal to or less than 40° toward an incident side with respect to the normal direction, and when a second light intensity is an intensity of light entering the lens sheet at an incident angle ranging from equal to or more than 10° to equal to or more than 40° with respect to the normal direction, and, output from the lens sheet at an output angle ranging from equal to or more than 0° to equal to or less than 40° toward the incident side with respect to the normal direction, the first light intensity is greater than the second light intensity.

According to another aspect, a display device includes: a display portion including a liquid crystal layer; a lens sheet arranged on a display surface of the display portion; and a reflector arranged on an opposite side of the lens sheet across the liquid crystal layer. The lens sheet includes a plurality of prisms arranged in juxtaposition in a first direction. A value of a/b ranges from equal to or more than 1.0 to equal to or less than 1.5, where a is a height of each prism and b is a length of a bottom portion of each in the first direction.

### BRIEF DESCRIPTION OF THE DRAWINGS

FIG. 1 is a cross-sectional view illustrating a configuration example of a display device according to a first embodiment;

FIG. 2 is a plan view illustrating the configuration example of the display device according to the first embodiment;

FIG. 3 is a perspective view illustrating a configuration example of a lens sheet according to the first embodiment;

FIG. 4 is a cross-sectional view illustrating a configuration example of a prism according to the first embodiment;

FIG. 5 is a perspective view illustrating a configuration example of a display panel according to the first embodiment;

FIG. 6 is a cross-sectional view illustrating the configuration example of the display panel according to the first embodiment;

FIG. 7 is a diagram comparing the prism to a pixel according to the first embodiment;

FIG. 8 is a diagram illustrating an incident direction and an output direction of light, in the display device according to the first embodiment;

FIG. 9 is a diagram illustrating, in the display device according to the first embodiment, incident light entering the lens sheet at an incident angle ranging from 70° to 90° inclusive with respect to a normal direction of a display surface and output light output from the lens sheet at an output angle ranging from 0° to 40° inclusive toward the incident side with respect to the normal direction of the display surface;

FIG. 10 is a diagram illustrating, in the display device according to the first embodiment, incident light entering the lens sheet at an incident angle ranging from 10° to 40° inclusive with respect to the normal direction of the display surface and output light output from the lens sheet at an output angle ranging from 0° to 40° inclusive toward the incident side with respect to the normal direction of the display surface;

FIG. 11 is a diagram illustrating observation angles of the display devices according to the first embodiment and the visibility of images;

FIG. 12 is a diagram illustrating incident light entering a display device and output light output from the display device, according to a comparative example;

FIG. 13 is a diagram illustrating a relation between the installation heights of the display devices according to the comparative example and the visibility of images;

FIG. 14 is a graph illustrating simulation results of respective values of a/b for the output angles and light intensities of the output light when the incident angle of the incident light is from 70° to 90° inclusive;

FIG. 15 is a graph illustrating simulation results of respective values of a/b for the output angles and the light intensities of the output light when the incident angle of the incident light is from 10° to 40° inclusive;

FIG. 16 is a diagram illustrating a range of the output angles in the simulation;

FIG. 17 is a diagram illustrating an angle range of an absorption axis of a polarizing plate;

FIG. 18 is a graph illustrating a relation between the incident angle of the incident light and transmittance for each polarization direction of the light;

FIG. 19 is a cross-sectional view illustrating a configuration example of a display device according to a first modification of the first embodiment;

FIG. 20 is a cross-sectional view illustrating a configuration example of a display device according to a second modification of the first embodiment;

FIG. 21 is a cross-sectional view illustrating a configuration example of a display device according to a third modification of the first embodiment; and

FIG. 22 is a diagram illustrating a configuration example of an electronic shelf label according to a second embodiment.

### DETAILED DESCRIPTION

Modes (embodiments) for carrying out the present disclosure will be described below in detail with reference to the drawings. The contents described in the embodiments are not intended to limit the present disclosure. Components described below include components easily conceivable by those skilled in the art and components substantially identical therewith. Furthermore, the components described below can be appropriately combined. The disclosure is given by way of example only, and various changes made without departing from the spirit of the disclosure and easily conceivable by those skilled in the art naturally fall within the scope of the present disclosure. The drawings may possibly illustrate the width, the thickness, the shape, and other elements of each unit more schematically than the actual aspect to simplify the explanation. These elements, however, are given by way of example only and are not intended to limit interpretation of the present disclosure. In the specification and the drawings, components similar to those previously described with reference to a preceding drawing are denoted by like reference numerals, and overlapping explanation thereof will be appropriately omitted. In this disclosure, when an element A is described as being “on” another element B, the element A can be directly on the other element B, or there can be one or more elements between the element A and the other element B.

### First Embodiment

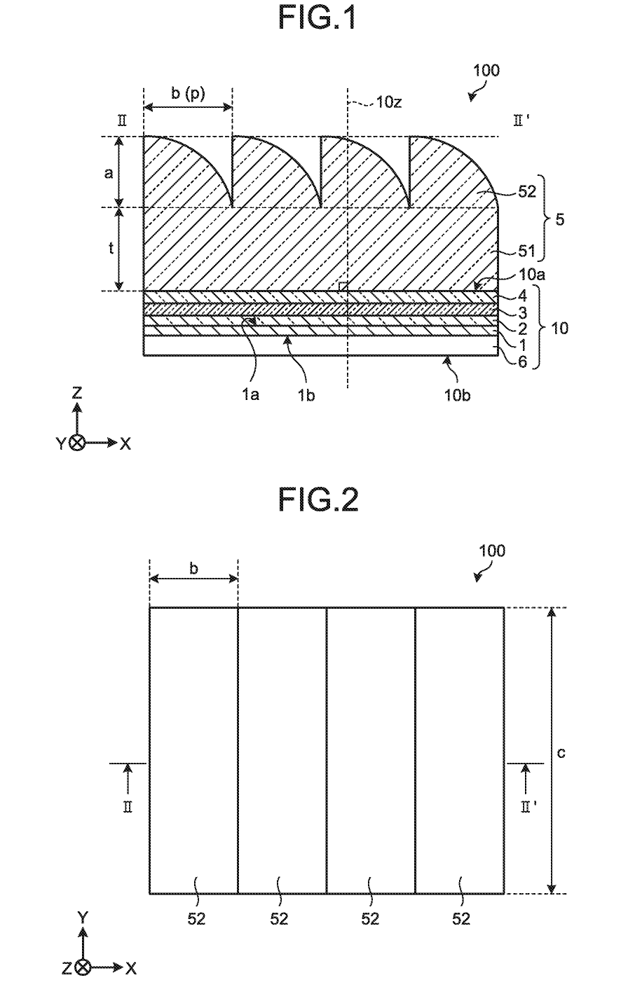

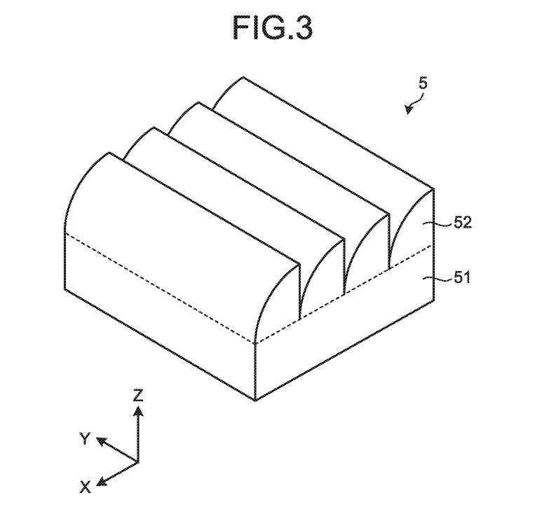

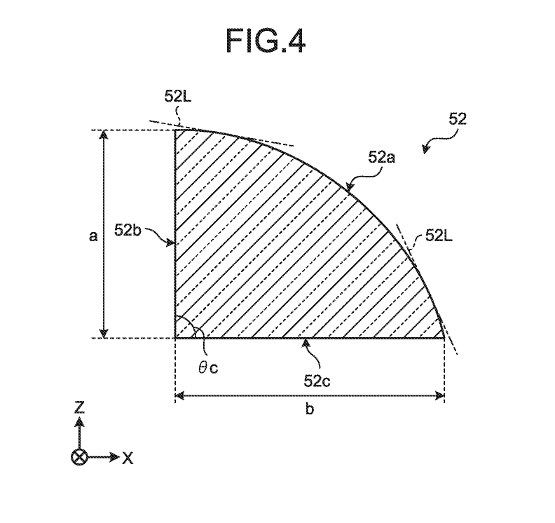

FIG. 1 is a cross-sectional view illustrating a configuration example of a display device according to a first embodiment. FIG. 2 is a plan view illustrating the configuration example of the display device according to the first embodiment. FIG. 1 illustrates a cross-section cut along the II-II line in FIG. 2. FIG. 3 is a perspective view illustrating a configuration example of a lens sheet according to the first embodiment. FIG. 4 is a cross-sectional view illustrating a configuration example of a prism according to the first embodiment. In the present specification, an X-axis direction indicates a first direction in which a plurality of prisms are juxtaposed, a Y-axis direction indicates a second direction orthogonal to the X-axis direction in planar view, and a Z-axis direction indicates a thickness direction of the display device. The Z-axis direction is also a normal direction of a display surface of a display panel. In the present specification, a side pointed by an arrow of the X-axis direction is described as a positive side of the X-axis direction and an opposite side of the side pointed by the arrow is described as a negative side of the X-axis direction.

As illustrated in FIGS. 1 to 4, a display device 100 according to the first embodiment includes a display panel 10, and a lens sheet 5 that is arranged on a display surface 10a of the display panel 10. The display panel 10 includes a liquid crystal layer 1, a counter substrate 2, a retardation plate 3, a polarizing plate 4, and an array substrate 6. The counter substrate 2 is arranged on a surface 1a of the liquid crystal layer 1. The retardation plate 3 is arranged on the counter substrate 2. The polarizing plate 4 is arranged on the retardation plate 3. The array substrate 6 is arranged on a rear surface 1b of the liquid crystal layer 1. The surface 1a of the liquid crystal layer 1 faces the display surface 10a of the display panel 10. The polarizing plate 4 has a function of converting light having entered from the display surface 10a into linearly polarized light. The retardation plate 3 has a function of converting the linearly polarized light having entered from the polarizing plate 4 into circularly polarized light. The retardation plate 3 and the polarizing plate 4 are pasted together, and the polarizing plate 4 and the lens sheet 5 are pasted together, by adhesives having translucency and optical isotropy, for example.

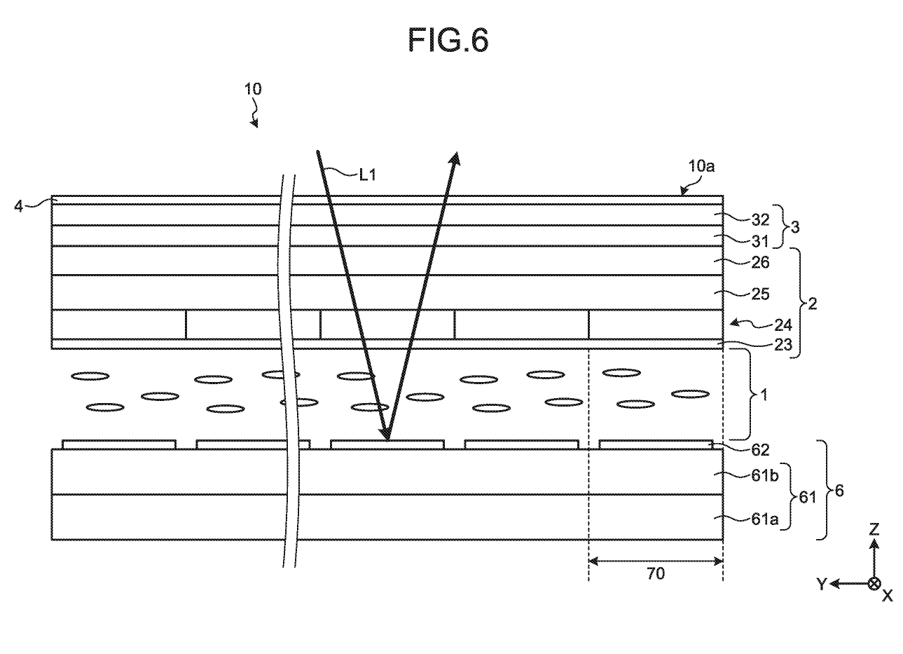

In the display device 100 according to the first embodiment, the display panel 10 displays an image on the display surface 10a by using reflected light reflected by reflectors of the array substrate 6, the reflected light being a part of the light that has entered from the display surface 10a. Thus, the display device 100 does not include a light source such as a backlight on a back surface 10b of the display panel 10. This configuration allows the display device 100 to achieve low power consumption, and an image on the display surface 10a to be easily viewable even in a lighted environment. The reflectors of the array substrate 6 are exemplified by pixel electrodes 62 (see FIG. 6) which will be described later.

The lens sheet 5 includes a base 51, and a plurality of prisms 52 provided on the base 51. The prisms 52 are arranged in juxtaposition in the X-axis direction. The base 51 and the prisms 52 have translucency and are made of a material having a refractive index higher than that of an air layer. For example, the base 51 and the prisms 52 are made of glass, or a resin material such as acrylic resin, and polyethylene terephthalate (PET). The base 51 and the prisms 52 are integrally formed of the same material, for example. The prisms 52 are formed by cutting the surface of a glass plate or the surface of a resin material with a laser beam, for example. When the prisms 52 are made of the resin material, they can be molded by a roll-to-roll technique using a roll mold.

The shape of each of the prisms 52 in planar view (hereinafter referred to as a planar shape) is rectangle, for example. The shape of each of the prisms 52 in cross-sectional view (hereinafter referred to as a cross-sectional shape) is a circular sector or an oval sector, with a central angle θc of 90°, for example. The prism 52 has a first surface 52a, a second surface 52b, and a bottom surface 52c. The first surface 52a is a curved surface facing the X-axis direction and the Z-axis direction, and the cross-sectional shape thereof is arcuate. The first surface 52a is a curved surface that satisfies the following Expression (1) in cross-sectional view illustrated in FIG. 4, for example. The first surface 52a has the same shape along the Y axis, for example.

$$X = a \sqrt{1 - \frac{{Z}^{2}}{{b}^{2}}} \\ where X \geq 0 and Z \geq 0 \qquad Expression ( 1 )$$

Assuming that a normal direction 10z of the display surface 10a is 0°, the inclination of a tangent line 52L of the first surface 52a with respect to the normal direction 10z gradually decreases from the negative side of the X-axis direction toward the positive side of the X-axis direction. For example, the inclination of the tangent line 52L with respect to the normal direction 10z is large on the side that is close to the second surface 52b, and is small on the side that is far from the second surface 52b. The second surface 52b is a plane that is in parallel with a Y-Z plane. The second surface 52b is located at the end portion on the negative side of the X-axis direction, and is in parallel with the normal direction 10z of the display surface 10a. The bottom surface 52c is a plane that is in parallel with an X-Y plane, and is orthogonal to the normal direction 10z of the display surface 10a.

In the lens sheet 5, assuming that “a” is the height of the prism 52 from the base 51, and “b” is the length of the bottom surface 52c of the prism 52 in the X-axis direction, a value of a/b obtained by dividing “a” by “b” is from 1.0 to 1.5 inclusive (from equal to or more than 1.0 to equal to or less than 1.5) (1.0≤a/b≤1.5), for example. This configuration allows the lens sheet 5 to efficiently output light that has entered therein at an incident angle ranging from 70° to 90° inclusive (from equal to or more than 70° to equal to or less than 90°) (70°≤incident angle≤90° with respect to the normal direction 10z, at a specific output angle. The specific output angle is in an angle range ranging from 0° to 40° inclusive (from equal to or more than 0° to equal to or less than 40°) (0°≤output angle≤40°) at which the light is output toward the incident side with respect to the normal direction 10z. Accordingly, the lens sheet 5 can output the light, which has entered the lens sheet 5 at the incident angle ranging from 70° to 90° inclusive with respect to the normal direction 10z, at the output angle ranging from 0° to 40° inclusive toward the incident side with respect to the normal direction 10z with high light intensity. This point will be described later with reference to the results of simulation.

In the lens sheet 5, assuming that the thickness of the base 51 is a thickness t, the thickness t ranges from 10 μm to 50 μm inclusive (10 μm≤t≤50 μm). When the thickness t of the base 51 exceeds 50 μm, a diffusing amount of light increases when the light is transmitted through the base 51, which may blur an image displayed on the display surface 10a. When the thickness t of the base 51 is below 10 μm, the strength of the lens sheet 5 lowers, which may cause the lens sheet 5 to be prone to cracking in the manufacturing process. Thus, the base 51 having the thickness t ranging from 10 μm to 50 μm inclusive can prevent the blurring of the image displayed on the display surface 10a, and deterioration of a yield rate of the lens sheet due to insufficient strength.

An arrangement interval p of the prisms 52 in the X-axis direction ranges from 10 μm to 100 μm inclusive. In the display device 100 according to the first embodiment, the prisms 52 are continuously arranged along the X-axis direction. Thus, the length b of the bottom surface 52c of the prism 52 in the X-axis direction (hereinafter referred to as the length of the prism 52) and the arrangement interval p of the prisms are of the same value. Assuming the length of the prism 52 in the Y-axis direction to be a width c (hereinafter referred to as the width of the prism 52), the width c of the prism 52 is greater than the length b of the prism 52. The length b of the prism 52 is set so as not to coincide with the length of one pixel, as described later. The arrangement interval p of the prisms 52 may be constant or may be random, as long as it ranges from 10 μm to 1000 μm inclusive, for example.

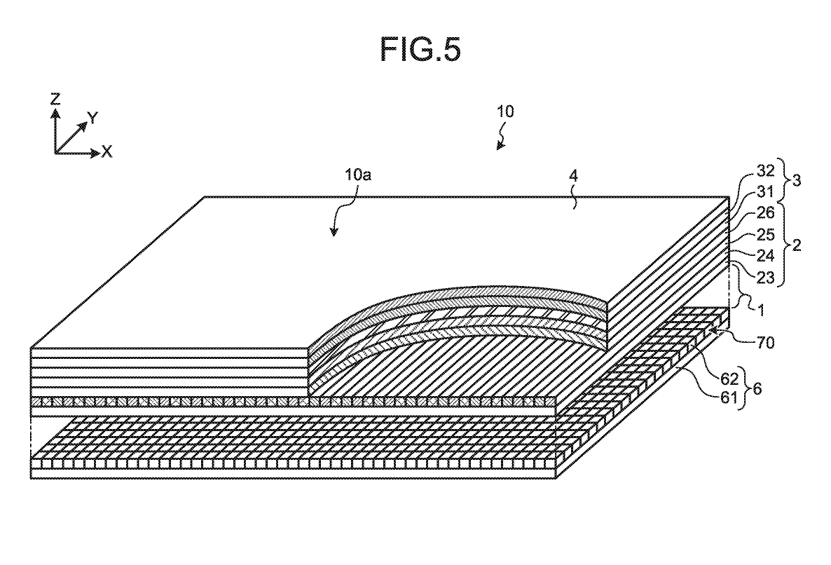

FIG. 5 is a perspective view illustrating a configuration example of the display panel according to the first embodiment. FIG. 5 illustrates a state in which a part of the display panel 10 is cut out. FIG. 6 is a cross-sectional view illustrating the configuration example of the display panel according to the first embodiment. As illustrated in FIGS. 5 and 6, the counter substrate 2 includes a common electrode 23, color filters 24, a second substrate 25, and an anisotropic scattering member (LCF) 26. Of both surfaces of the second substrate 25, the anisotropic scattering member 26 is provided on one surface of the second substrate 25 located on the display surface 10a side. The color filter 24 and the common electrode 23 are provided on the other surface of the second substrate 25.

The common electrode 23 is formed of a translucent conductive material, such as indium tin oxide (ITO). The color filters 24 include filters of four colors, red (R), green (G), blue (B), and white (W), for example. Because the second substrate 25 includes the color filters (CF) 24, the second substrate 25 may be referred to as a CF substrate. The second substrate 25 is a translucent substrate, such as a glass substrate. The anisotropic scattering member 26 is a non-isotropic layer that scatters the light reflected by the pixel electrodes 62. The anisotropic scattering member 26 employs a light control film (LCF), for example. The retardation plate 3 includes a quarter-wave plate 31, and a half-wave plate 32 that is provided on the quarter-wave plate 31.

The array substrate 6 includes a first substrate 61, and the pixel electrodes 62 that are provided on the first substrate 61. The first substrate 61 includes a circuit substrate 61a, and a flattening film 61b that is provided on the circuit substrate 61a. The circuit substrate 61a includes a glass substrate, circuit elements, signal lines, and scanning lines. The circuit elements, the signal lines and scanning lines are provided on the glass substrate. The signal lines and the scanning lines intersect with each other, and sub pixels 70 are arranged at intersections in a row-column configuration. Examples of the circuit elements include a switching element such as a thin film transistor (TFT), and a capacitive element. The flattening film 61b is formed on the surface of the circuit substrate 61a on which the circuit elements, the signal lines, and the scanning lines are formed, and flattens the surface of the circuit substrate 61a. Because the circuit elements include the TFT, the first substrate 61 may be referred to as a TFT substrate.

The pixel electrodes 62 are formed on the flattening film 61b. The pixel electrode 62 is formed of metal such as aluminum, for example, and is provided for each sub pixel 70. Incident light L1 that has entered from the display surface 10a of the display panel 10 is transmitted through the polarizing plate 4, the retardation plate 3, the counter substrate 2, and the liquid crystal layer 1, and then reaches the pixel electrodes 62. Then, the incident light L1 is diffusely reflected by the pixel electrodes 62. The light is scattered by the diffuse reflection, and the scattered light travels toward the display surface 10a. In the first embodiment, the pixel electrodes 62 may be provided with a scattering pattern to scatter the incident light L1. Assuming that the rate of the reflected light to the incident light is a reflection rate, it is preferable that the material of the pixel electrode 62 be of a material having the reflection rate of 80% or greater.

The liquid crystal layer 1 includes nematic liquid crystal, for example. The liquid crystal layer 1 transmits or blocks the light entering the liquid crystal layer 1 for each sub pixel 70 by a voltage being applied between the common electrode 23 and the pixel electrode 62 which will be described later. A change in voltage level of the pixel electrode 62 adjusts a light transmission level in the liquid crystal layer 1 for each sub pixel 70.

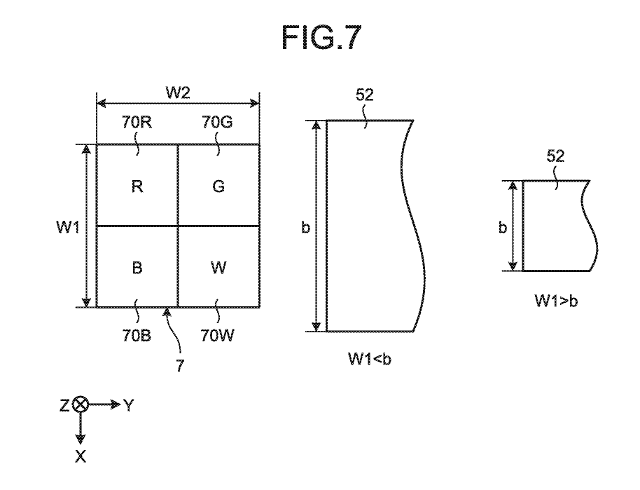

FIG. 7 is a diagram comparing the prism to a pixel according to the first embodiment. As illustrated in FIG. 7, a pixel 7 that is a unit to form a color image includes a plurality of sub pixels 70, for example. In the first embodiment, the pixel 7 includes a sub pixel 70R that displays red (R), a sub pixel 70B that displays blue (B), a sub pixel 70G that displays green (G), and a sub pixel 70W that displays white (W), for example. The pixel 7 has a square shape, and is constituted by two sub pixels in the X-axis direction and two sub pixels in the Y-axis direction. For example, assuming that the length of the pixel 7 in the X-axis direction is W1 and the length of the pixel 7 in the Y-axis direction is W2, W1=W2 is satisfied. The length W1 in the X-axis direction and the length W2 in the Y-axis direction may be different from each other.

In the first embodiment, it is preferable that the length b of the prism 52 be greater than or smaller than the length W1 of the pixel 7. It is preferable that the length c in the Y-axis direction of the prism 52 also be greater than or smaller than the length W1 of the pixel 7. Accordingly, the length b of the prism 52 and the length W1 of the pixel 7 do not coincide with each other, which can prevent moire.

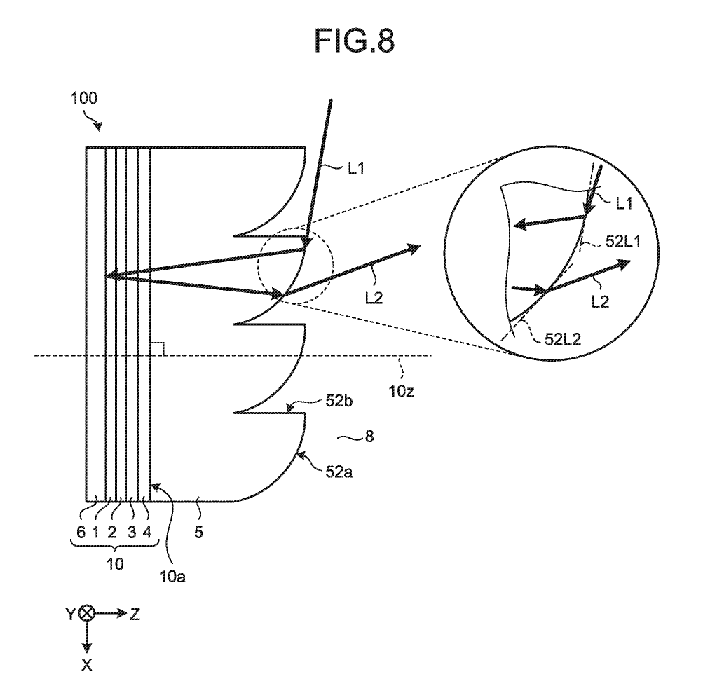

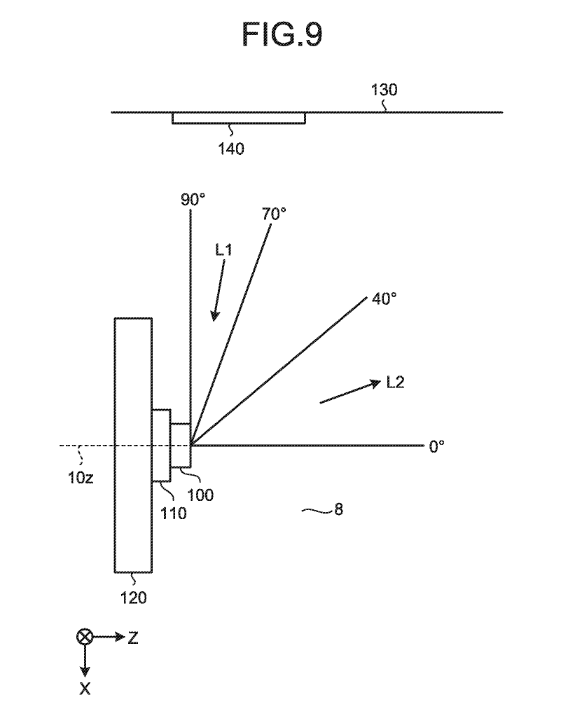

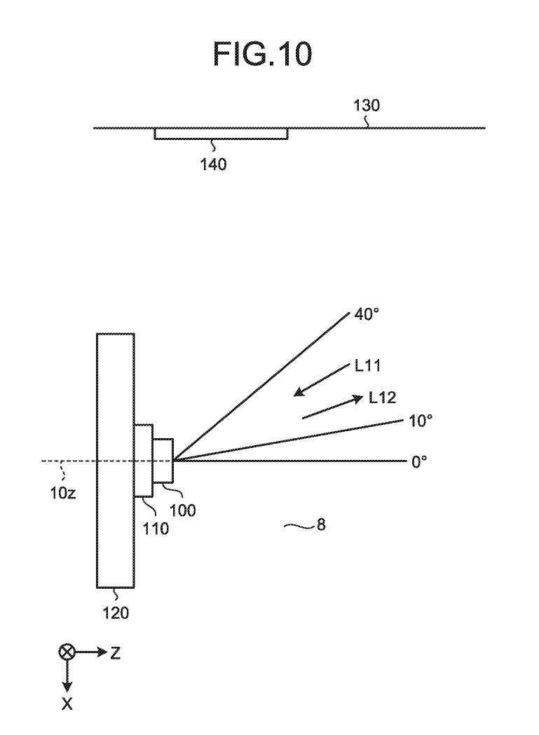

FIG. 8 is a diagram illustrating the incident direction and the output direction of the light, in the display device according to the first embodiment. FIG. 9 is a diagram illustrating, in the display device according to the first embodiment, the incident light entering the lens sheet at the incident angle ranging from 70° to 90° inclusive with respect to the normal direction of the display surface and the output light output from the lens sheet at the output angle ranging from 0° to 40° inclusive toward the incident side with respect to the normal direction of the display surface. FIG. 10 is a diagram illustrating, in the display device according to the first embodiment, the incident light entering the lens sheet at the incident angle ranging from 10° to 40° inclusive with respect to the normal direction of the display surface and the output light output from the lens sheet at the output angle ranging from 0° to 40° inclusive toward the incident side with respect to the normal direction of the display surface. As illustrated in FIGS. 8 to 10, the display device 100 is used in a state of being arranged perpendicularly to the floor surface, under an environment in which a lighting fixture 140 is mounted on a ceiling 130, for example. The display device 100 is mounted via a mounting member 110 on an indoor wall surface or on a shelf 120 or the like arranged indoors, in a state where the normal direction 10z of the display surface 10a is directed to the horizontal direction and the second surface 52b of the prism 52 is directed to the ceiling 130. The horizontal direction in FIGS. 8 to 10 is the Z-axis direction.

As illustrated in FIGS. 8 and 9, the lighting fixture 140 illuminates the display device 100 from above or obliquely from above. The incident light L1 entering the first surface 52a of the prism 52 from the lighting fixture 140 is, when entering the first surface 52a, refracted at an interface between an air layer 8 and the first surface 52a of the prism 52. The refracted light is turned into linearly polarized light by the polarizing plate 4, and is transmitted through the retardation plate 3 to become circularly polarized light. The circularly polarized light is transmitted through the counter substrate 2 and the liquid crystal layer 1, and is diffusely reflected by the pixel electrodes 62 of the array substrate 6. The diffusely reflected light is transmitted through the liquid crystal layer 1, the counter substrate 2, the retardation plate 3, and the polarizing plate 4, and enters the lens sheet 5. Then, the light that has entered the lens sheet 5 travels toward the first surface 52a while being further scattered. This light is, when output from the first surface 52a to the air layer 8, refracted at the interface between the first surface 52a and the air layer 8 mainly toward the direction in which the incident light L1 has entered (hereinafter referred to as the incident direction).

In this example, at the first surface 52a, the inclination of a tangent line 52L1 at the incident position of the incident light L1 is different from the inclination of a tangent line 52L2 at the output position of output light L2. For example, the inclination of the tangent line 52L2 with respect to the normal direction 10z at the output position is smaller than the inclination of the tangent line 52L1 with respect to the normal direction 10z at the incident position. Due to the difference between the inclination of the tangent line 52L1 at the incident position and the inclination of the tangent line 52L2 at the output position, the incident angle of the incident light and the output angle of the output light, with respect to the normal direction 10z, become different from each other. The output light L2 output to the air layer 8 from the first surface 52a is visually recognized by an indoor observer, for example, as an image.

As illustrated in FIG. 9, in the display device 100, when the incident light L1 enters the prism 52 at the incident angle ranging from 70° to 90° inclusive with respect to the normal direction 10z, the light reflected by the pixel electrodes 62 (see FIG. 6), which is a part of the incident light L1, is output toward the incident side with respect to the normal direction 10z at the output angle ranging from 0° to 40° inclusive from the prism 52. As illustrated in FIG. 10, in the display device 100, when incident light L11 enters the prism 52 at the incident angle ranging from 10° to 40° inclusive with respect to the normal direction 10z, the light reflected by the pixel electrodes 62, which is a part of the incident light L11, is output toward the incident side with respect to the normal direction 10z at the output angle ranging from 0° to 40° inclusive from the prism 52.

In the first embodiment, a first light intensity is an intensity of the output light L2 that is output toward the incident side at the output angle ranging from 0° to 40° inclusive from the prism 52, when the incident light L1 enters the prism 52 at the incident angle ranging from 70° to 90° inclusive. A second light intensity is an intensity of output light L12 that is output toward the incident side at the output angle ranging from 0° to 40° inclusive from the prism 52, when the incident light L11 enters the prism 52 at the incident angle ranging from 10° to 40° inclusive. In the display device 100 of the first embodiment, the first light intensity is greater than the second light intensity. As a result, even when the observer looks into the display surface of the display device 100 obliquely from above, the luminance of the display surface seen from the observer is high, and thus the visibility of the image projected to the display surface is improved.

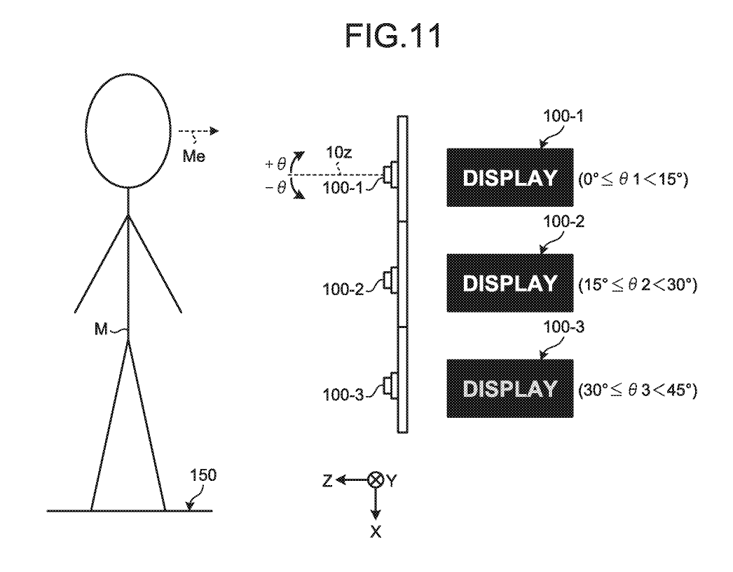

FIG. 11 is a diagram illustrating observation angles of the display devices according to the first embodiment and the visibility of images. In FIG. 11, the difference among display devices 100-1, 100-2, and 100-3 is only their installation heights from a floor surface 150. The configuration of each of the display devices 100-1, 100-2, and 100-3 is the same as that of the display device 100 illustrated in FIG. 1, for example. Observation angles θ1 to θ3 indicated in FIG. 11 are angles formed by the normal direction 10z of the respective display surfaces of the display devices 100-1, 100-2, and 100-3 and a line of sight Me of an observer M. When the observation angle is positive (+), the eyes of the observer M are at a position higher than the display surface of the display device 100, which means that the observer M looks into the display surface from above. When the observation angle is negative, the eyes of the observer M are at a position lower than the display surface of the display device 100, which means that the observer M looks up the display surface from below.

As illustrated in FIG. 11, when the observation angle θ1 ranges from 0° to 15° inclusive (0°≤θ1<15°) or the observation angle θ2 ranges from 15° to 30° inclusive (15°≤θ2≤30°), the display surface of the respective display devices 100-1 and 100-2 seen from the observer M exhibits high luminance. Thus, the observer M can easily visually recognize images such as characters, which are displayed on the respective display surfaces of the display devices 100-1 and 100-2. In FIG. 11, the image of the characters is displayed as “DISPLAY”. However, the characters are changed as appropriate. Although the luminance of the display surface of the display device 100-3 seen from the observer M becomes somewhat lower than that of the display device 100-1 or the display device 100-2 when θ3 exceeds 40°, the observer M can visually recognize the characters displayed on the display surface of the display device 100-3 sufficiently.

In the display device 100 according to the first embodiment, when the incident light L1 that has entered at the incident angle ranging from 70° to 90° inclusive with respect to the normal direction 10z is reflected by the reflective electrodes, the output light L2 is output via the prism 52 at the output angle ranging from 0° to 40° inclusive toward the incident side with respect to the normal direction 10z of the display surface, and thus the light intensity of the output light L2 becomes high. In FIG. 11, the +θ side is the incident side. This configuration improves the visibility of the images displayed on the respective display surfaces of the display devices 100-1, 100-2, and 100-3.

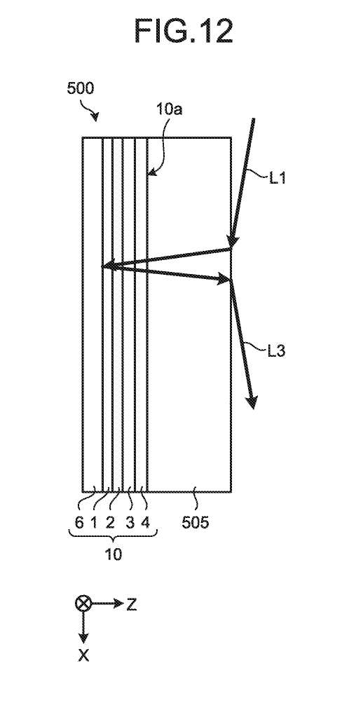

FIG. 12 is a diagram illustrating the incident light entering a display device and the output light output from the display device, according to a comparative example. As illustrated in FIG. 12, a display device 500 according to the comparative example includes the display panel 10, and a translucent sheet 505 that is arranged on the display surface 10a of the display panel 10. The translucent sheet 505 is not a lens, and its surface is flat. For example, the translucent sheet 505 has a flat surface on the opposite side of the surface facing the display surface 10a. The translucent sheet 505 is made of the same material as that of the lens sheet according to the first embodiment. The translucent sheet 505 has the same thickness as that of the base 51 of the lens sheet according to the first embodiment.

In FIG. 12, the lighting fixture illuminates the display device 500 from above or obliquely from above. The incident light L1 entering the translucent sheet 505 from the lighting fixture is, when entering the surface thereof, refracted at the interface between the air layer 8 and the translucent sheet 505. The refracted light is turned into linearly polarized light by the polarizing plate 4, and is transmitted through the retardation plate 3 to become circularly polarized light. The circularly polarized light is transmitted through the counter substrate 2 and the liquid crystal layer 1, and is diffusely reflected by the pixel electrodes 62 of the array substrate 6. The diffusely reflected light is transmitted through the liquid crystal layer 1, the counter substrate 2, the retardation plate 3, the polarizing plate 4, and the translucent sheet 505, and is output to the air layer 8. Because the comparative example has no prism 52 like the first embodiment, output light L3 is output toward the opposite side of the incident direction of the incident light L1.

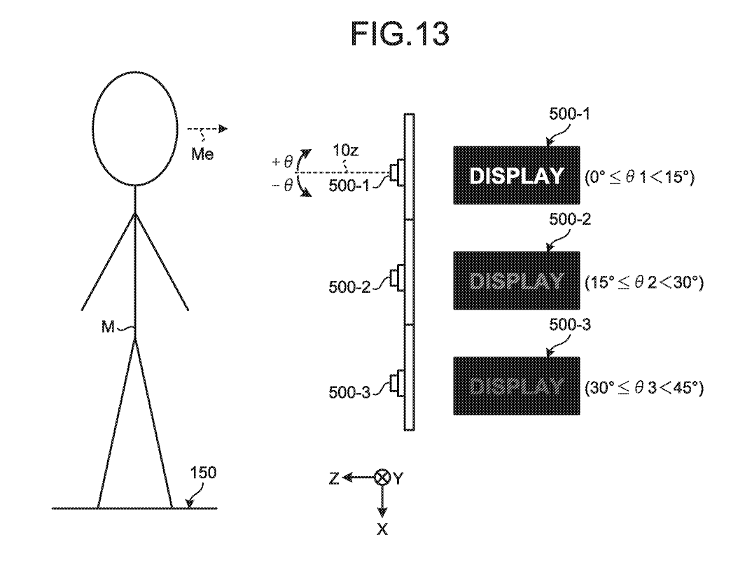

FIG. 13 is a diagram illustrating a relation between the installation heights of the display devices according to the comparative example and the visibility of images. In FIG. 13, the difference among display devices 500-1, 500-2, and 500-3 is only the installation heights from the floor surface 150. The configuration of each of the display devices 500-1, 500-2, and 500-3 is the same as that of the display device 500 illustrated in FIG. 12, for example. The observation angles θ1 to θ3 indicated in FIG. 13 are angles formed by the normal direction 10z of the respective display surfaces of the display devices 500-1, 500-2, and 500-3 and the line of sight Me of the observer M.

As illustrated in FIG. 13, when the observation angle θ1 ranges from 0° to 15° inclusive (0°≤θ1<15°), the display surface of the display device 500-1 seen from the observer M exhibits high luminance. Thus, the observer M can visually recognize with ease the characters displayed on the display surface of the display device 500-1. However, the luminance of the respective display surfaces of the display devices 500-2 and 500-3 seen from the observer M is low. Thus, the observer M is hard to visually recognize the characters displayed on the respective display surfaces of the display devices 500-2 and 500-3. As illustrated in FIG. 12, in the display device 500 according to the comparative example, the output light L3 is output toward the opposite side of the incident direction of the incident light L1 with a high light intensity. This deteriorates the visibility of the images displayed on the respective display surfaces of the display devices 500-2 and 500-3 illustrated in FIG. 13. This is because the main output direction of the output light L3 is on the −θ side indicated in FIG. 13 in the display devices 500-2 and 500-3 according to the comparative example.

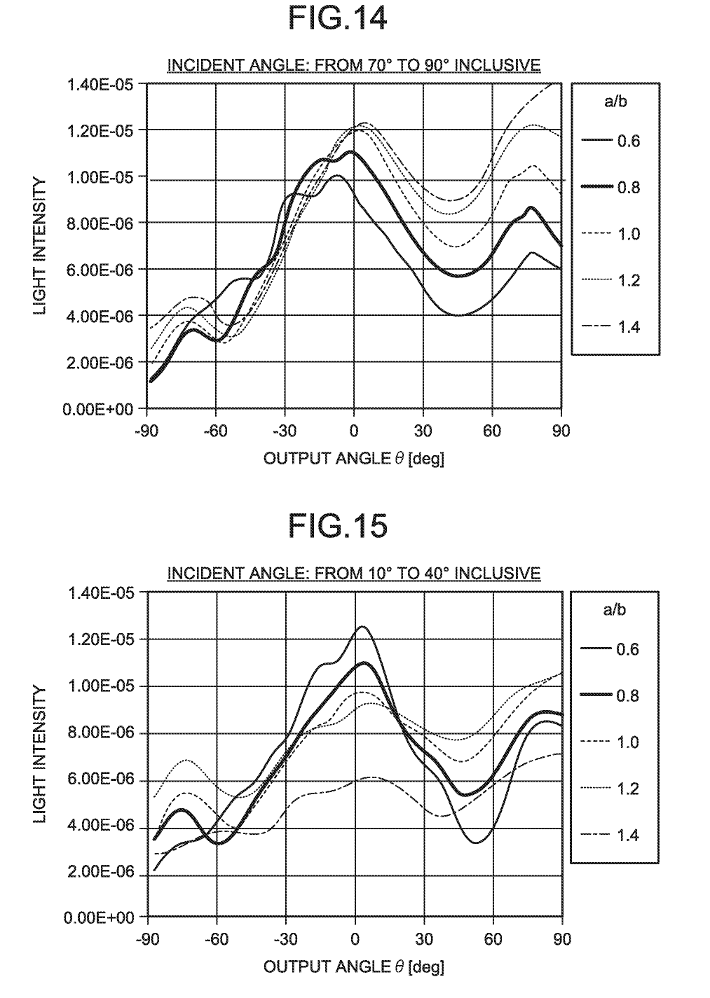

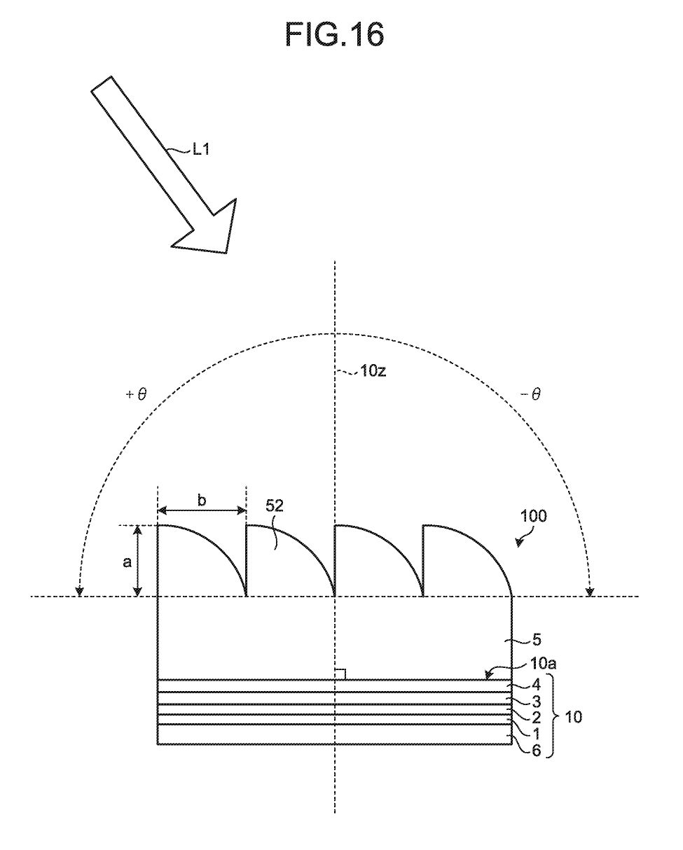

FIG. 14 is a graph illustrating simulation results of respective values of a/b for the output angles and the light intensities of the output light when the incident angle of the incident light is from 70° to 90° inclusive. FIG. 15 is a graph illustrating simulation results of respective values of a/b for the output angles and the light intensities of the output light when the incident angle of the incident light is from 10° to 40° inclusive. FIG. 16 is a diagram illustrating the range of the output angles in the simulation. In FIGS. 14 and 15, the abscissa axis represents the output angle of the output light, and the ordinate axis represents the light intensity of the output light.

The present simulation assumed two conditions in which the incident angles of the incident light with respect to the display surface 10a were from 70° to 90° inclusive, and from 10° to 40° inclusive. The incident light of the present simulation was assumed to be the incident light L1 illustrated in FIG. 9 and the incident light L11 illustrated in FIG. 10. In the present simulation, a detection range of the output angles θ of the output light output from the lens sheet 5 were assumed to be from −90° to +90° inclusive with respect to the normal direction 10z, as illustrated in FIG. 16. In the present simulation, the value of a/b was assumed to have five patterns, i.e., “0.6”, “0.8”, “1.0”, “1.2”, and “1.4”.

As illustrated in FIG. 14, when the incident angle is from 70° to 90° inclusive, the light intensity of the output light output at the output angle ranging from 0° to 40° inclusive increases as the value of a/b becomes greater. As illustrated in FIG. 15, when the incident angle is from 10° to 40° inclusive, the light intensity of the output light output at the output angle of approximately 0° increases as the value of a/b becomes smaller. Moreover, focusing on the range of the output angles from 0° to 40° inclusive, when the value of a/b is “1.4”, “1.2”, or “1.0”, the light intensity of the output light when the incident angle is from 70° to 90° inclusive is higher than that when the incident angle is from 10° to 40° inclusive. According to the above simulation results, by setting the value of a/b to be from 1.0 to 1.4 inclusive, the incident light L1 that has entered at the incident angle ranging from 70° to 90° inclusive is output at the output angle ranging from 0° to 40° inclusive with the high light intensity.

Based on the above simulation results, by setting the value of a/b to be greater than 1.4, the output light can be output at the output angle ranging from 0° to 40° inclusive with an even higher light intensity. However, when the value of a/b exceeds 1.5, the aspect ratio of the prism 52 becomes high, which makes it difficult to manufacture the prism 52 by cutting or the like. Thus, in the display device 100 according to the first embodiment, the value of a/b is set to be from 1.0 to 1.5 inclusive.

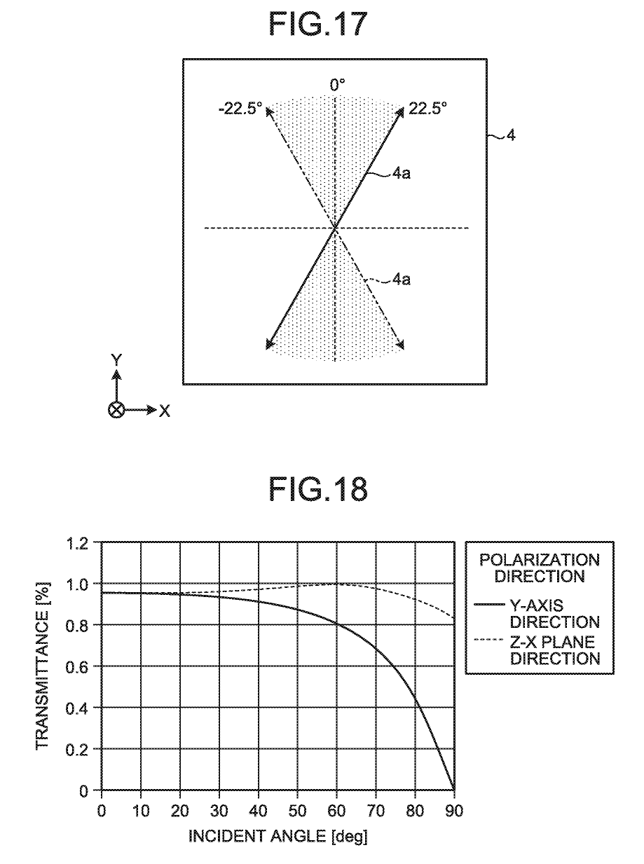

FIG. 17 is a diagram illustrating an angle range of an absorption axis of the polarizing plate. FIG. 18 is a graph illustrating a relation between the incident angle of the incident light and transmittance for each polarization direction of the light. The abscissa axis in FIG. 18 represents the incident angle of the incident light L1 with respect to the normal direction 10z of the display surface 10a illustrated in FIG. 8 and others. The ordinate axis in FIG. 18 represents the transmittance of the incident light L1 in the lens sheet 5 illustrated in FIG. 8 and others. Specifically, FIG. 18 illustrates the relation between the incident angle and the transmittance in the case where the lens sheet 5 is formed of a high refractive material (n=1.52) and the incident light L1 has entered the lens sheet 5 from the air layer 8 (n=1).

As illustrated in FIG. 8, when the light has entered the lens sheet 5 obliquely from the air layer 8, a polarization component of the incident light L1 in the Z-X plane orthogonal to the Y-axis direction has higher transmittance than a polarization component of the incident light L1 in the Y-axis direction, as illustrated in FIG. 18. This tendency becomes noticeable as the incident angle of the incident light L1 becomes greater. Thus, when seen from the polarizing plate 4 illustrated in FIG. 1 and others, out of the two polarization components of the incident light L1, the light intensity of the polarization component in the Z-X plane is greater than that of the polarization component in the Y-axis direction. Thus, in the first embodiment, as illustrated in FIG. 17, an absorption axis 4a of the polarizing plate 4 is set to be at an angle in parallel or approximately parallel to the Y-axis direction. For example, the absorption axis 4a of the polarizing plate 4 is set in a range from −22.5° to 22.5° inclusive (equal to or more than −22.5° to equal to or less than 22.5°) (−22.5°≤absorption axis≤22.5°) with respect to the Y-axis direction. This configuration allows the polarization component in the Y-axis direction to be absorbed in the polarization plate 4, and prevents the polarization component in the Z-X plane from being absorbed. The configuration thus can reduce the loss of the incident light L1 in the polarizing plate 4, thereby allowing the display device 100 to efficiently use the incident light L1.

As described above, the display device 100 according to the first embodiment includes the display panel 10 including the liquid crystal layer 1, the lens sheet 5 arranged on the display surface 10a of the display panel 10, and the array substrate 6 arranged on the opposite side of the lens sheet 5 across the liquid crystal layer 1. The array substrate 6 includes the pixel electrodes 62 formed of metal such as aluminum, for example. The lens sheet 5 outputs the light reflected by the pixel electrodes 62, the reflected light being a part of the incident light L1 that has entered the lens sheet 5. For example, the lens sheet 5 includes the prisms 52 arranged in juxtaposition in the X-axis direction. Assuming that the height of the prism 52 is “a” and the length of the bottom surface 52c of the prism 52 in the X-axis direction is “b”, the value of a/b is from 1.0 to 1.5 inclusive.

This configuration allows the intensity of the output light L2 (first light intensity) that is output at the output angle ranging from 0° to 40° inclusive when the incident angle is from 70° to 90° inclusive to be greater than the intensity of the output light L12 (second light intensity) that is output at the output angle ranging from 0° to 40° inclusive when the incident angle is from 10° to 40° inclusive. Accordingly, as illustrated in FIGS. 9 and 11 for example, when the respective display surfaces of the display devices 100, 100-1, 100-2, and 100-3 are placed perpendicularly to the floor surface 150 under the environment in which the lighting fixture 140 is mounted on the ceiling 130, the illumination light (incident light) output from the lighting fixture 140 can be reflected by the pixel electrodes 62 in the array substrate 6 and be efficiently output in the direction inclined in the range from 0° to 40° inclusive toward the incident side from the normal direction 10z of the display surface 10a.

As a result, not only when the observer M sees the display surface 10a of the display device 100-1 from the front but also when the observer M looks into the respective display surfaces 10a of the display devices 100-2 and 100-3 obliquely from above, the luminance of the respective display surfaces 10a seen from the observer M is high, and thus the observer M can see the images projected to the respective display surfaces with high visibility. In this manner, the first embodiment can provide a reflective liquid crystal display device excellent in visibility of images.

In the first embodiment, the display panel 10 corresponds to a “display portion” of a display device according to one aspect, and the pixel electrode 62 corresponds to a “reflector” of the display device according to the one aspect.

First Modification

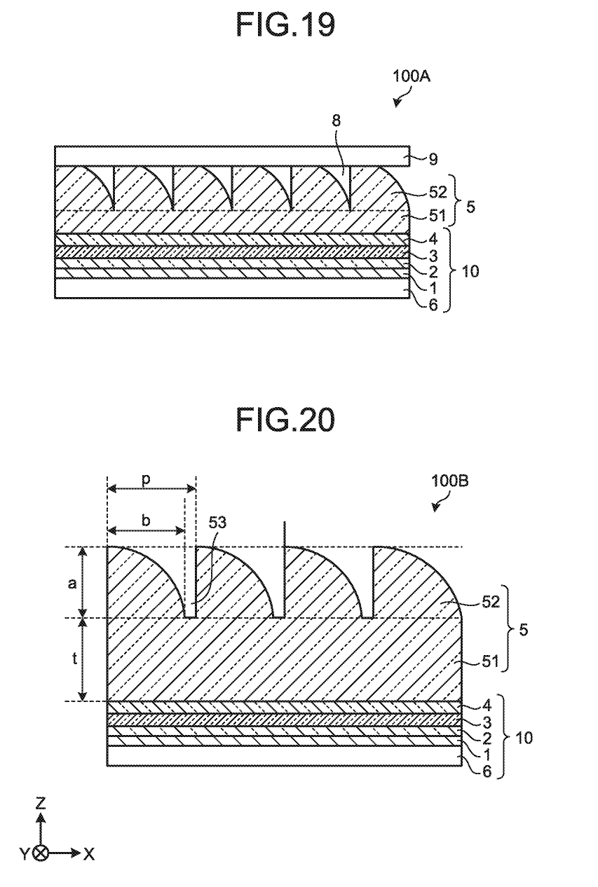

FIG. 19 is a cross-sectional view illustrating a configuration example of a display device according to a first modification of the first embodiment. As illustrated in FIG. 19, a display device 100A according to the first modification of the first embodiment includes a translucent base material 9 arranged on the lens sheet 5, and a material layer 8 arranged between the translucent base material 9 and the prisms 52. The material layer 8 has a refractive index lower than that of the translucent base material 9 and that of the prisms 52, and is an air layer, for example. The translucent base material 9 is made of glass, or a resin material such as acrylic resin and polyethylene terephthalate (PET), for example. The translucent base material 9 and the lens sheet 5 are pasted together by adhesives having translucency and optical isotropy, for example.

The translucent base material 9 and the lens sheet 5 may be integrally formed of an identical material. Accordingly, the surfaces of the prisms 52 are covered with the translucent base material 9, which can prevent the surfaces of the prisms 52 from having scratches or being deformed by scraping. Furthermore, the surfaces of the prisms 52 are covered with the translucent base material 9, which can prevent intrusion of dust or the like into the uneven portions between the prisms 52. In this manner, the display device 100A can improve scratch resistance and antifouling performance by including the translucent base material 9.

Second Modification

FIG. 20 is a cross-sectional view illustrating a configuration example of a display device according to a second modification of the first embodiment. The description has been given to the display device 100 in which the prisms 52 are arranged in the X-axis direction without spacing and the length b of the prism 52 and the arrangement interval p of the prisms 52 are of the same value. In the second modification of the first embodiment, the length b of the prism 52 and the arrangement interval p of the prisms may be of different values. As illustrated in FIG. 20, in the lens sheet 5 included in a display device 100B according to the second modification of the first embodiment, a gap 53 is provided between the prisms 52 adjacent in the X-axis direction, and the arrangement interval p of the prisms 52 is greater than the length b of the prism 52.

Even in such a configuration, as long as the value of a/b is from 1.0 to 1.5 inclusive, the intensity of the light that is output at the output angle ranging from 0° to 40° inclusive toward the incident side, out of the output light L2 output from the lens sheet 5, becomes greater when the incident angle of the incident light L1 is from 70° to 90° inclusive than when the incident angle is from 10° to 40° inclusive.

Third Modification

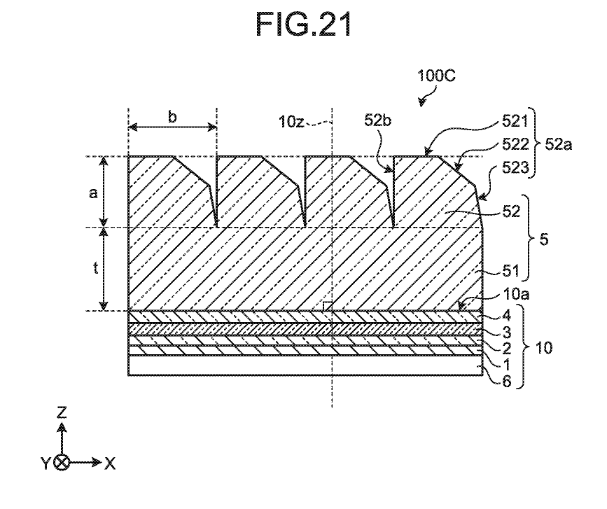

FIG. 21 is a cross-sectional view illustrating a configuration example of a display device according to a third modification of the first embodiment. The description has been given to the display device 100 in which the first surface 52a of the prism 52 is a curved surface. In the third modification of the first embodiment, the first surface 52a of the prism 52 may not be a curved surface.

As illustrated in FIG. 21, in a display device 100C according to the third modification of the first embodiment, the first surface 52a of the prism 52 includes a horizontal surface 521, a first inclined surface 522, and a second inclined surface 523. The horizontal surface 521 is orthogonal to the normal direction 10z of the display surface 10a. One end of the horizontal surface 521 is connected to the second surface 52b. The other end of the horizontal surface 521 is connected to one end of the first inclined surface 522. The first inclined surface 522 is inclined such that the one end of the first inclined surface 522 is closer to the second surface 52b than the other end of the first inclined surface 522. The other end of the first inclined surface 522 is connected to one end of the second inclined surface 523. The other end of the second inclined surface 523 is connected to the base 51. The second inclined surface 523 is inclined such that the one end of the second inclined surface 523 is closer to the second surface 52b than the other end of the second inclined surface 523. For example, the inclination of the second inclined surface 523 with respect to the normal direction 10z is smaller than the inclination of the first inclined surface 522 with respect to the normal direction 10z.

Accordingly, in the first surface 52a, the inclination with respect to the normal direction 10z becomes smaller as it becomes farther from the second surface 52b. Even in such a configuration, as long as the value of a/b is from 1.0 to 1.5 inclusive, the intensity of the output light that is output at the output angle ranging from 0° to 40° inclusive toward the incident side, out of the output light output from the lens sheet 5, becomes greater when the incident angle of the incident light L1 is from 70° to 90° inclusive than when the incident angle is from 10° to 40° inclusive.

### Second Embodiment

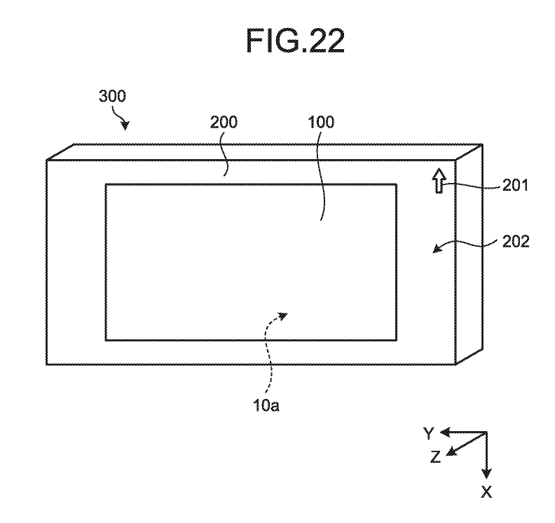

FIG. 22 is a diagram illustrating a configuration example of an electronic shelf label according to a second embodiment. As illustrated in FIG. 22, an electronic shelf label 300 according to the second embodiment includes the display device 100 described in the first embodiment, and a housing 200 that houses the display device 100. The electronic shelf label 300 is, for example, a price tag used for a store shelf on which products are put on display, and displays the price and others of a product on the display surface 10a of the display device 100. The electronic shelf label 300 can change the price and others displayed on the display surface 10a by receiving a signal from a controller, which is not illustrated, by radio or the like.

A mark is provided on the housing 200, the mark indicating an incident direction of light which is predetermined when the electronic shelf label 300 is mounted on a store shelf or the like. For example, a mark 201 indicating the incident direction of light entering from a lighting fixture or the like is provided on a front 202 of the housing 200. The incident direction of the light is the direction in which the second surface 52b of the prism 52 illustrated in FIG. 1 and others faces.

This allows a worker to correctly mount the electronic shelf label 300 on the shelf or the like such that the second surface 52b of the prism 52 faces the ceiling on which the lighting fixture is provided. As a result, the illumination light output from the lighting fixture 140 can be made incident on the lens sheet 5 illustrated in FIG. 1 and others at the incident angle ranging from 70° to 90° inclusive. This can increase the luminance of the display surface 10a seen from the observer M, and the observer M can visually recognize with ease the price and others being projected onto the display surface 10a. Accordingly, the second embodiment can provide the electronic shelf label that exhibits excellent visibility of the image.

While the preferred embodiments and the modifications thereof according to the present disclosure have been described, the embodiments and the modifications thereof are not intended to limit the present disclosure. The contents disclosed in the embodiments and the modifications thereof are given by way of example only, and various changes may be made without departing from the spirit of the present disclosure. For example, the reflective liquid crystal display device capable of color display has been exemplified as the display device 100 of the first embodiment. However, the present disclosure is not limited to the reflective liquid crystal display device supporting color display and it may be a reflective liquid crystal display device supporting monochromatic display. Appropriate changes made without departing from the spirit of the present disclosure naturally fall within the technical scope of the present disclosure.

The present disclosure includes the following aspects:

(1) A display device comprising:

a display portion including a liquid crystal layer;

a lens sheet arranged on a display surface of the display portion; and

a reflector arranged on an opposite side of the lens sheet with the liquid crystal layer interposed between the reflector and the lens sheet, wherein

the lens sheet outputs light reflected by the reflector, the reflected light being a part of incident light that has entered the lens sheet, and

when a first light intensity is an intensity of light entering the lens sheet at an incident angle ranging from equal to or more than 70° to equal to or less than 90° with respect to a normal direction of the display surface, and, output from the lens sheet at an output angle ranging from equal to or more than 0° to equal to or less than 40° toward an incident side with respect to the normal direction, and

when a second light intensity is an intensity of light entering the lens sheet at an incident angle ranging from equal to or more than 10° to equal to or less than 40° with respect to the normal direction, and output from the lens sheet at an output angle ranging from equal to or more than 0° to equal to or less than 40° toward the incident side with respect to the normal direction,

the first light intensity is greater than the second light intensity.

(2) The display device according to (1), wherein the lens sheet includes a plurality of prisms arranged in juxtaposition in a first direction, and

a value of a/b ranges from equal to or more than 1.0 to equal to or less than 1.5, where a is a height of each prism and b is a length of a bottom portion of each prism in the first direction.

(3) A display device comprising:

a display portion including a liquid crystal layer;

a lens sheet arranged on a display surface of the display portion; and

a reflector arranged on an opposite side of the lens sheet across the liquid crystal layer, wherein

the lens sheet includes a plurality of prisms arranged in juxtaposition in a first direction, and

a value of a/b ranges from equal to or more than 1.0 to equal to or less than 1.5, where a is a height of each prism and b is a length of a bottom portion of each prism in the first direction.

(4) The display device according to (2) or (3), wherein

the lens sheet includes a base located between the prisms and the liquid crystal layer, and

the base has a thickness ranging from equal to or more than 10 μm to equal to or less than 50 μm.

(5) The display device according to any one of (2) to (4), wherein an arrangement interval of the prisms in the first direction ranges from equal to or more than 10 μm to equal to or less than 100 μm.
(6) The display device according to (5), wherein the arrangement interval is constant.
(7) The display device according to (5), wherein the arrangement interval is random.
(8) The display device according to any one of (2) to (7), wherein

each of the prisms includes a first surface inclined with respect to the normal direction, and a second surface in parallel with the normal direction, and

the second surface is located at an end portion of each of the prisms in the first direction.

(9) The display device according to (2) to (8), wherein

the display portion further includes a polarizing plate arranged between the liquid crystal layer and the lens sheet, and

an absorption axis of the polarizing plate is inclined at an angle ranging from equal to or more than −22.5° to equal to or less than 22.5° with respect to a second direction orthogonal to the first direction in planar view.

(10) The display device according to any one of (2) to (9), further comprising:

a translucent base material arranged on the lens sheet, and

a material layer arranged between the translucent base material and the prisms, wherein

a refractive index of the material layer is lower than a refractive index of the translucent base material and a refractive index of the prisms.

(11) The display device according to any one of (2) to (9), further comprising:

a translucent base material arranged on the lens sheet, and

an air layer arranged between the translucent base material and the prisms.

(12) An electronic shelf label comprising:

the display device according to any one of (1) to (11); and

a housing that houses the display device, wherein

the housing is provided with a mark indicating a predetermined incident direction of light.

What is claimed is:

1. A display device comprising:
a display portion including a liquid crystal layer;
a lens sheet arranged on a display surface of the display portion; and
a reflector arranged on an opposite side of the lens sheet with the liquid crystal layer interposed between the reflector and the lens sheet, wherein
the lens sheet outputs light reflected by the reflector, the reflected light being a part of incident light that has entered the lens sheet, and
when a first light intensity is an intensity of light entering the lens sheet at an incident angle ranging from equal to or more than 70° to equal to or less than 90° with respect to a normal direction of the display surface, and, output from the lens sheet at an output angle ranging from equal to or more than 0° to equal to or less than 40° toward an incident side with respect to the normal direction, and
when a second light intensity is an intensity of light entering the lens sheet at an incident angle ranging from equal to or more than 10° to equal to or less than 40° with respect to the normal direction, and, output from the lens sheet at an output angle ranging from equal to or more than 0° to equal to or less than 40° toward the incident side with respect to the normal direction,
the first light intensity is greater than the second light intensity.

2. The display device according to claim 1, wherein
the lens sheet includes a plurality of prisms arranged in juxtaposition in a first direction, and
a value of a/b ranges from equal to or more than 1.0 to equal to or less than 1.5, where a is a height of each prism and b is a length of a bottom portion of each prism in the first direction.

3. A display device comprising:
a display portion including a liquid crystal layer;
a lens sheet arranged on a display surface of the display portion; and
a reflector arranged on an opposite side of the lens sheet across the liquid crystal layer, wherein
the lens sheet includes a plurality of prisms arranged in juxtaposition in a first direction, and
a value of a/b ranges from equal to or more than 1.0 to equal to or less than 1.5, where a is a height of each prism and b is a length of a bottom portion of each prism in the first direction.

4. The display device according to claim 2, wherein
the lens sheet includes a base located between the prisms and the liquid crystal layer, and
the base has a thickness ranging from equal to or more than 10 μm to equal to or less than 50 μm.

5. The display device according to claim 2, wherein an arrangement interval of the prisms in the first direction ranges from equal to or more than 10 μm to equal to or less than 100 μm.

6. The display device according to claim 5, wherein the arrangement interval is constant.

7. The display device according to claim 5, wherein the arrangement interval is random.

8. The display device according to claim 2, wherein
each of the prisms includes a first surface inclined with respect to the normal direction, and a second surface in parallel with the normal direction, and
the second surface is located at an end portion of each of the prisms in the first direction.

9. The display device according to claim 2, wherein
the display portion further includes a polarizing plate arranged between the liquid crystal layer and the lens sheet, and
an absorption axis of the polarizing plate is inclined at an angle ranging from equal to or more than −22.5° to equal to or less than 22.5° with respect to a second direction orthogonal to the first direction in planar view.

10. The display device according to claim 2, further comprising:
a translucent base material arranged on the lens sheet, and
a material layer arranged between the translucent base material and the prisms, wherein
a refractive index of the material layer is lower than a refractive index of the translucent base material and a refractive index of the prisms.

11. The display device according to claim 2, further comprising:
a translucent base material arranged on the lens sheet, and
an air layer arranged between the translucent base material and the prisms.

12. An electronic shelf label comprising:
the display device according to claim 1; and
a housing that houses the display device, wherein
the housing is provided with a mark indicating a predetermined incident direction of light.
